(19) United States
(12) Patent Application Publication
(10) Pub. No.: US 2004/0151460 A1
(43) Pub. Date: Aug. 5, 2004

(54) Deep trenches for optical and electrical isolation

(76) Inventors: Daniel Kitcher, Oxon (GB); Ian Edward Day, Oxford (GB); Ralf Dieter Pechstedt, Oxon (GB); Andrew Alan House, Oxford (GB)

Correspondence Address: LAHIVE & COCKFIELD, LLP., 28 STATE STREET, BOSTON, MA, 02109, US

(21) Appl. No.: 10/479,495

(22) PCT Filed: May 29, 2002
(86) PCT No.: PCT/GB02/02521

(30) Foreign Application Priority Data
May 30, 2001 (GB) 0113031.9

(51) Int. Cl. G02B 6/10; G02B 6/12

(52) U.S. Cl. 385/129; 385/14

(57) ABSTRACT

An integrated optical device comprising at least one optical waveguide (1) formed on a substrate, the waveguide (1) being of elongate form with an optical axis extending along its length, at least one interceptor trench (3, 4, 5 or 6) being provided in the substrate adjacent at least one side of the waveguide (1), the trench (3, 4, 5,6) presenting a surface to intercept stray light travelling in the substrate in a direction substantially parallel to the optical axis of the waveguide (1), said surface being angled with respect to the direction of travel of said stray light so as to alter the direction of travel of the stray light intercepted thereby.

### TECHNICAL FIELD

This invention relates to an Integrated optical device comprising at least one waveguide formed on a substrate and, in particular, to an arrangement for reducing problems caused by stray light within the substrate.

### BACKGROUND PRIOR ART

A common problem with waveguides of an integrated optical device is the presence of stray light in the substrate on which the waveguides are formed. Although most of the light is guided by the waveguides, some light inevitably escapes to the substrate, e.g. where light is input into an end of a waveguide or where light leaves the end of a waveguide or due to leakage of light from the waveguide, e.g. around bends in the waveguide or at junctions between waveguides. Such stray light can cause cross-talk between waveguides or may reach light detectors provided on the device. In either case, it reduces the signal/noise ratio for the device.

### SUMMARY OF INVENTION

The present invention seeks to reduce the problem caused by such stray light. According to a first aspect of the invention, there is provided an integrated optical device comprising at least one optical waveguide formed on a substrate, the waveguide being of elongate form with an optical axis extending along its length, at least one interceptor trench being provided in the substrate adjacent at least one side of the waveguide, the trench presenting a surface to intercept stray light travelling in the substrate in a direction substantially parallel to the optical axis of the waveguide, said surface being angled with respect to the direction of travel of said stray light so as to alter the direction of travel of the stray light intercepted thereby.

According to a second aspect of the invention, there is provided an integrated optical device comprising an array of two or more rib waveguides formed in an optically conductive layer, each rib waveguide comprising a slab portion and rib projecting therefrom, substantially all of the optically conductive layer being removed from a selected region between the slab regions of the or each pair of adjacent waveguides.

Preferred and optional features of the invention will be apparent from the following description and from the subsidiary claims of the specification.

### BRIEF DESCRIPTION OF THE DRAWINGS

The invention will now be further described, merely by way of example, with reference to the accompanying drawings, in which:

FIG. 1 is a plan view of a plurality of waveguides with trenches in the substrate adjacent thereto in accordance with a preferred embodiment of the invention;

FIGS. 2A and 2B are, respectively, cross sectional views of a conventional pair of waveguides and of a trench formed between two waveguides according to another embodiment of the invention;

FIGS. 3A and 3B are plan views of two further forms of trench formed adjacent a waveguide according to further embodiments of the invention;

FIG. 4 is a plan view of an arrayed waveguide grating (AWG), which is a device to which the invention is particularly suited, showing the positions at which trenches are provided adjacent waveguides to improve the performance of the device; and

FIGS. 5 and 6 are plan views of further forms of trench that may be used.

### BEST MODE OF THE INVENTION

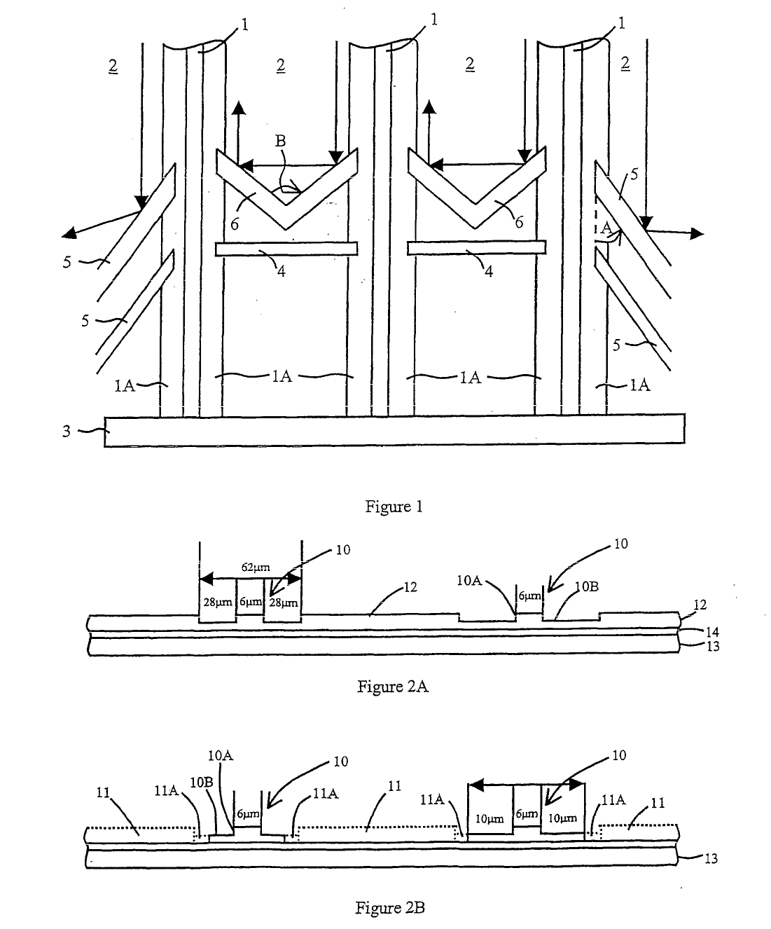

FIG. 1 shows a plan view of three parallel waveguides 1, in this case, rib waveguides, formed in a substrate 2 and leading to a detector region 3, which may typically comprise a row of photodiodes. In such an arrangement, the majority of stray light in the substrate 2 is travelling substantially parallel to the optical axes of the waveguides 1.

Three types of interceptor trenches are shown in FIG. 1, in the substrate 2, adjacent the waveguides 1, each having substantially parallel sides and being relatively long compared to their width. A first type comprises a substantially straight bar-shaped trench 4 extending substantially perpendicular to the waveguides 1. In the arrangement shown, this trench 4 extends between two waveguides with each end thereof terminating close to one of the waveguides 1. A second type comprises a substantially straight bar-shaped trench 5 extending away from a waveguide at an angle A to the optical axis thereof, e.g. at an angle in the range 10 to 80 degrees to the optical axis. One end of the trench 5 terminates close to a waveguide and the trench extends far enough away from the waveguide to shield the detector region 3 from stray light. This type of trench is particularly suited to the substrate adjacent the outermost waveguides of an array of waveguides and may extend to the edge of the device. A third type comprises a V-shaped trench 6 (in plan view) comprising two angled portions similar to the second type described above but meeting at a point. In the arrangement shown, the trench 6 extends between two waveguides with each end terminating close to a waveguide and the V-shape pointing towards the detector region 3.

The trenches have vertical side walls, i.e. they extend perpendicular to the plane of the substrate 2, and thus deflect light within the plane of the substrate 2.

The first type of trench 4 substantially reduces the transmission of stray light travelling parallel to the waveguides 1 towards the detector region 3. Back reflection at each of the surfaces of the trench 4 lying substantially perpendicular to the direction of travel of the stray light typically attenuates the light by about 30%, so the trench 4 reflects approximately 50% of the light incident thereon.

The second type of trench 5 acts to deflect the stray light away from the array of waveguides 1. If the angle of incidence of the light on the surface of the trench 5 is greater than the critical angle, substantially all of the light will be totally internally reflected and very little will penetrate through the trench 5. With a substrate 2 formed of silicon (and with air in the trench), the critical angle is about 17 degrees. Thus, the angle A is preferably 73 degrees or less.

The third type of trench 6 acts as a retro-reflector as one portion of the V-shape deflects the light towards the other portion thereof, which then deflects the light back substantially in the direction it came from. This is clearly preferable to deflecting the stray light towards one of the waveguides. Each arm of the V-shaped trench preferably lies at an angle of 5 to 85 degrees to the optical axes of the waveguides and, with a silicon substrate, the included angle B of the V-shape is preferably in the range of 90 to 164 degrees, to act as a retro-reflector, although angles towards 90 degrees are preferred as they retro-reflect a greater range of the incoming rays. Smaller included angles B, e.g. in the range 10 to 60 degrees can also be used as the V-shape then acts as a light trap; the light being attenuated due to the scattering at each reflection.

A series of trenches may be arranged in the substrate 2, the series extending in the direction parallel to the optical axes of the waveguides 1. The series may comprise two or more trenches of the same type or two or more trenches of two or more types. In the arrangement shown in FIG. 1, a series of two trenches 5 each of the second type is shown adjacent the outer waveguides 1, the second trench 5 in each series serving to deflect any light which has managed to pass through the first trench 5 in the series. FIG. 1 also shows a series comprising a V-shaped trench 6 of the third type followed by a straight trench 4 of the first type between adjacent waveguides 1, the straight trench 4 serving to prevent transmission of light which is not retro-reflected by the V-shaped trench 6.

It will be appreciated that the trenches described above need not be straight. The second type of trench 5 may be curved so long as the surface presented thereby to the stray light tends to deflect the light away from the adjacent waveguide. Similarly, the V-shaped trenches 6 may have a semi-circular, parabolic or other curved shape which serves to reflect a substantial proportion of the stray light received back in substantially the direction from which it came.

The ends of the trenches preferably terminate as close as possible to the waveguides 1 to minimize the gap between the trench and the waveguide through which stray light can pass but should not be so close as to significantly perturb the optical mode within the waveguide. For rib waveguides formed in a silicon substrate, the trenches preferably extend into trenches 1A, which run parallel to and define the rib 1B of the waveguide 1. Preferably, the ends of the trenches terminate at a distance 1 to 10 microns from the side faces of the rib 1 and typically around 5 microns therefrom.

A device such as that shown may be formed on a silicon-on insulator (SOI) chip in which the silicon layer 2 in which the rib waveguide 1 is formed is separated from a supporting substrate (typically also of silicon) by an optical confinement layer, e.g. an insulating layer of silicon dioxide (see FIG. 2). In this case, the trenches 4, 5 and 6 preferably extend through the silicon layer 2 to the insulating layer so that stray light cannot pass beneath the trenches. Depending on the thickness of the silicon layer 2, the trenches 4, 5 and 6 may have a depth of between 1 and 50 microns but typically have a depth in the range 5 to 10 microns.

The width of the trenches 4, 5 or 6 should be sufficient to enable easy fabrication thereof, e.g. by etching, and would typically be at least 1 micron and preferably at least 10 microns.

The waveguides 1 may be spaced apart from each other (from the side face of one rib to the side face of the adjacent rib) by a distance in the range 20 to 1000 microns depending on the application. For an array of waveguides 1 leading to an array of photodiodes, the array may comprise up to 40 waveguides spaced apart by a distance in the range 50 to 500 microns, e.g. around 250 microns.

FIG. 2A is a cross-sectional view of a conventional, unmodified pair of parallel rib waveguides 10. FIG. 2B is a cross-sectional view of a corresponding arrangement with a trench 11 formed between the two parallel rib waveguides 10. The rib waveguides 10 are again formed in an SOI chip comprising a layer of silicon 12 separated from a substrate 13 by an insulating layer 14. In this case, rather than forming relatively narrow trenches in the silicon layer 12 to intercept stray light therein, the majority of the silicon layer 12 between the waveguides 10 is removed, e.g. by etching.

As shown in FIG. 2A, a conventional rib waveguide 10 comprises a rib 10A projecting from a slab region 10B in the silicon layer 12. The slab region 10B has a greater width than the rib 10A so the rib waveguide has a cross-section in the S form of an inverted T (although in some cases the rib may extend downwards from the slab region so having a T-shaped cross-section). The optical mode travels in the rib 10A and in the slab region 10B immediately beneath the rib and extending either side thereof. A typical rib waveguide may comprise a rib having a width of about 6 microns and a slab region having a total width of about 62 microns (so that it projects about 28 microns from each side of the rib). The slab region decreases the effective refractive index either side of the waveguide so serves to confine the optical mode laterally. The slab region typically has a thickness of about 2 to 3.5 microns (measured from the insulating layer 14) and the rib 10A typically projects about 4.5 to 6 microns from the upper surface of the slab region 10B. The silicon layer 12 between adjacent waveguides 10, which extends between the adjacent extremities of the slab regions 10B of the two waveguides, typically has a thickness of about 6.5 to 9.5 microns (this is usually the same as the combined thickness of the slab regions 10B and the height of the rib 10A projecting therefrom). It is in this silicon layer 12 between the waveguides 10 that stray light is present. Rib waveguides of other dimensions may also be used.

In the arrangement shown in FIG. 2B, the silicon layer 12 between the adjacent slab regions 10B is removed. Preferably, the silicon layer 12 is removed down to the insulating layer 14. A trench 11, represented by dotted lines in FIG. 2B (indicating the portion of the silicon layer 12 removed) is thus formed between the two waveguides 10. A similar trench 11 is preferably formed between each adjacent pair of waveguides 10 in the array and preferably also in the silicon layer 12 adjacent the outermost waveguides of the array. In the latter case, the trench 11 preferably extends far enough away from the waveguide to shield the detector region 3 and may extend to the edge of the chip.

In addition, as shown by dotted line regions 11A in FIG. 2B, the trench 11 preferably extends to some extent into the slab region 10B on each side of the waveguide. In the example shown, about 18 microns of slab region 10B is removed from each side of the waveguide leaving a slab region having a total width of about 26 microns, i.e. extending 10 microns from each side of the rib 10A. This extends the trench 11 as close as possible to the rib waveguide and so prevents transmission of light which is not guided by the rib waveguide. As the majority of the optical mode is confined within the vicinity of the rib, a slab region of 10 microns width on each side of the waveguide is sufficient to provide a lower effective refractive index to confine the optical mode laterally.

The trenches 11, i.e. the regions from which the silicon layer 12 is removed, preferably extend over as great a distance in a direction parallel to the optical axes of the waveguides 10, as can in practice be fabricated, thus may extend for a distance of several millimeters, i.e. two or more millimeters.

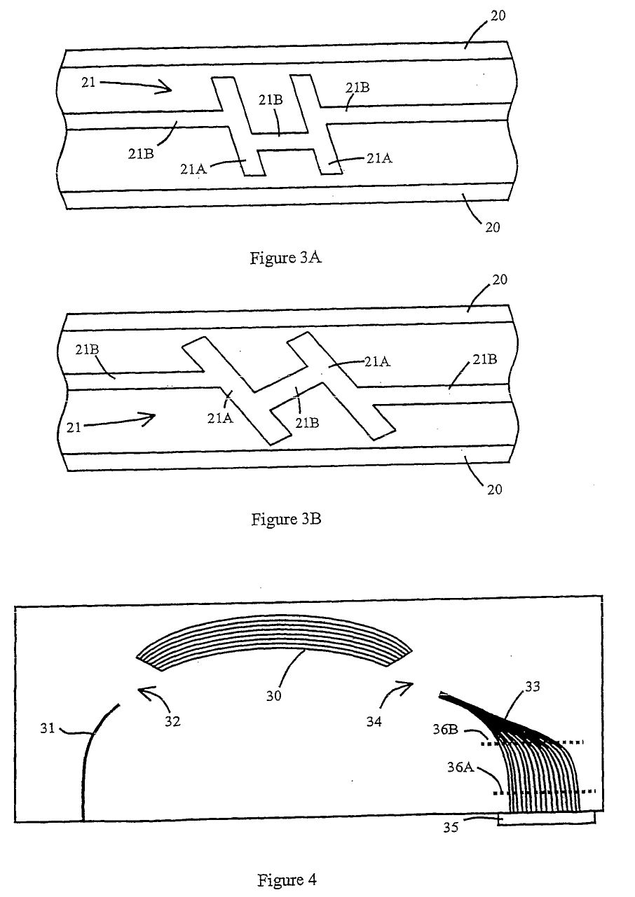

FIGS. 3A and 3B show plan views of a pair of parallel waveguides 20 and other forms of trench 21 provided therebetween. In these cases, the trenches comprise a series of angled portions 21A, somewhat similar to the second type of trench 5 described in relation to FIG. 1, with adjacent angled portions 21A being joined by linking portions 21B. The angled portion 21A and linking portions 21B together form a continuous trench between the adjacent waveguides 20 and thus provide electrical as well as optical isolation of the two waveguides.

The linking portions 21B are preferably arranged so as to avoid a straight line path extending along the trench. Thus, the linking portions 21B may be offset with respect to each other, as shown in FIG. 3A, and/or angled relative to each other, as shown in FIG. 3B. In each case, the trench has the form of a series of angled H-shapes linked together in a direction parallel to the waveguides 20.

As in the embodiments described above, the trenches 21 are preferably etched down to the bottom of the light conducting layer, i.e. down to the oxide layer in an SOI chip, and the angled portion preferably terminate close to the waveguides as in FIG. 1.

FIG. 4 shows a plan view of an arrayed waveguide grating (AWG) 30 comprising a first array of waveguides of different optical lengths so the output thereof interfere in a desired manner (not described here as this is well known and not relevant to the present invention). An input waveguide 31 directs a multi-wavelength optical signal towards an input end of the AWG 30 via a first star coupler 32 (also not described herein for similar reasons). The output of the AWG 30 is received by a second array 33 of waveguides via a second star coupler 34. The AWG 30 is preferably arranged to de-multiplex the signal input on waveguide 31 so that different wavelength bands are directed to each of the waveguides in the output array 33.

As shown, the input ends of the waveguides in the output array 33 are closely spaced with each other (typically between 5 to 25 microns apart). The waveguides then diverge from each other as they curve around so that the output ends of the waveguides again lie substantially parallel to each other but spaced apart by a greater distance to make it easier to direct the light from each output end to a respective light sensor in a light sensor array 35 positioned to receive the output of the output array 33 (as the receptive surfaces of the sensors are typically larger than the output faces of the waveguides). The output ends of the waveguides are typically spaced from each other by a distance in the range 25 to 500 microns.

Stray light may be present in the light conducting layer between the individual waveguides in the output array 33 and in the areas adjacent the output array 33 as mentioned above. The majority of the stray light in such an arrangement tends to be travelling approximately parallel to the waveguides towards the light sensor array 35 and thus gives rise to cross-talk between the waveguides and decreases the signalnoise ratio of the output of the light sensors. The arrangements of trenches described above may thus be used adjacent the output waveguides of such a device. FIG. 4 indicates by a dotted band 36A extending across the output end of the array 33 of waveguides, the position at which trenches such as those described in FIG. 1 are preferably provided. The band 36A is shown close to the output ends of the waveguides. In another arrangement it may be positioned close to a source of the stray light, e.g. close to the bends in the waveguides, as shown by band 36B.

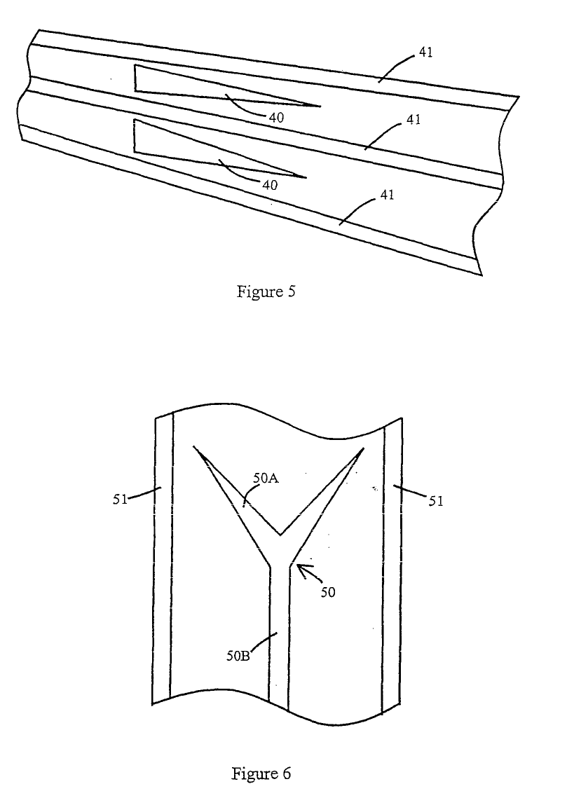

Other forms and shapes of trenches may be used to intercept and re-direct stray light travelling in the light conducting areas between waveguides. Triangular trenches 40 may be used between waveguides 41, e.g. as illustrated in the plan view shown in FIG. 5, the inclined surfaces provided by all three sides of the triangle serving to deflect light travelling substantially parallel to the waveguides 41.

Y-shaped trenches 50 may also be used between waveguides 51 as illustrated in the plan view shown in FIG. 6. The V-shaped part 50A of this corresponds with the third type of trench described in relation to FIG. 1 and the stem part 50B extending parallel to the waveguides 51 provides electrical isolation therebetween. A similar part extending parallel to the waveguides may be used to provide electrical isolation in conjunction with other shape trenches used to deflect the stray light.

The deep-etched trenches described above thus function to block routes through the light conductive layer between and adjacent the waveguides. The trenches described are primarily provided to re-direct the stray light by reflection or total internal reflection rather than to eliminate it. The remainder of the device thus needs to be designed so as not to be adversely affected by this re-directed stray light.

The formation of trenches such as those described above is relatively simple as they are generally formed by simple dry etching of the light conducting layer through an appropriate mask and this can be integrated with other etching steps used to define other features of the device, e.g. the rib waveguides. Etching in is SOI chips is also advantageous as the insulating layer forms a natural etch stop to define the depth of the etch. Etching also has the advantage that it is generally simpler to carry out than a doping process, particularly as the latter often involves a heating step which applies a thermal load on the chip so the method described above is particularly suited for use on devices comprising components that are sensitive to or may be damaged by heat treatment.

In further arrangements, light absorbing material may be provided in the trenches e.g. particles of carbon suspended in an adhesive, to absorb any light which passes through the wall of the trench into the interior thereof.

Alternatively, or additionally, light absorbing material may be provided on the edges of the chip, at least at positions towards which the stray light is directed. Serrations may also be used at the edge of the chip as described in U.S. Pat. No. 6,108,478.

Whilst the embodiments described above comprise straight, parallel waveguides, it will be appreciated that one or more of the waveguides may be curved. The trenches described above may thus also be used between and adjacent waveguides which are not straight and are not strictly parallel to each other but which nevertheless extend In generally similar directions.

As indicated above, the primary purpose of the trenches is to provide optical isolation. However, trenches such as those described above also electrically isolate areas of the device on opposite sides of the trench. This is particularly true when deep and long trenches are used but the presence of any form of trench helps electrically isolate areas due to the removal of all or substantially all of the electrically conducting material therebetween.

1. An integrated optical device comprising at least one optical waveguide formed on a substrate, the waveguide being of elongate form with an optical axis extending along its length, at least one interceptor trench being provided in the substrate adjacent at least one side of the waveguide, the trench presenting a surface to intercept stray light travelling in the substrate in a direction substantially parallel to the optical axis of the waveguide, said surface being angled with respect to the direction of travel of said stray light so as to alter the direction of travel of the stray light intercepted thereby.

2. An integrated optical device as claimed in claim 1 in which said surface lies substantially perpendicular to the optical axis of the waveguide.

3. An integrated optical device as claimed in claim 1 in which said surface is angled relative to the optical axis of the waveguide so as to re-direct stray light travelling substantially parallel to the optical axis by total internal reflection.

4. An integrated optical device as claimed in claim 1, 2 or 3 in which at least a portion of the interceptor trench has substantially parallel sides and is substantially longer than it is wide.

5. An integrated optical device as claimed in claims 2 and 4 in which said portion comprises a bar-shaped trench (in plan view) extending substantially perpendicular to the optical axis of the waveguide.

6. An integrated optical device as claimed in claim 3 and 4 in which said portion extends at an angle to the optical axis of the waveguide from a position adjacent the waveguide away from the direction from which the stray light is expected.

7. An integrated optical device as claimed in claim 6 in which said portion forms part of a V-shaped trench (in plan view).

8. An integrated optical device as claimed in claim 7 in which the V-shaped trench is arranged to re-direct stray light received thereby back in substantially the direction from which it came.

9. An integrated optical device as claimed in any preceding claim comprising a series of interceptor trenches spaced from each other in a direction substantially parallel to the optical axis of the waveguide.

10. An integrated optical device as claimed in claims 5, 7 and 9 in which the series comprises at least one V-shaped trench followed by at least one bar-shaped trench.

11. An integrated optical device as claimed in claim 9 in which the interceptor trenches in the series are linked together by linking trenches.

12. An integrated optical device as claimed in claim 11 arranged so that no straight line optical path exists through the series of linked trenches.

13. An integrated optical device as claimed in any of claims 1 to 8 in which an elongate trench is provided extending from said at least one interceptor trench in a direction substantially parallel to the optical axis of the waveguide.

14. An integrated optical device as claimed in any preceding claim comprising an array of two or more substantially parallel waveguides with said at least one interceptor trench being provided between the or each adjacent pair of waveguides.

15. An integrated optical device as claimed in claim 14 in which an array of light sensors is positioned to receive light from an output end of said array of waveguides.

16. An integrated optical device as claimed in claim 14 and 15 in which said array of waveguides is positioned to receive light from an arrayed waveguide grating.

17. An integrated optical device as claimed in claim 1 comprising an array of two or more substantially parallel waveguides formed in an optically conductive layer in which the interceptor trench removes substantially all of the optically conductive layer between the waveguides along a given length of the waveguides.

18. An integrated optical waveguide as claimed in claim 17 in which the given length is at least two or more millimeters.

19. An integrated optical device as claimed in any preceding claim in which the or each of the waveguides are substantially straight adjacent said interceptor trench.

20. An integrated optical device as claimed in any preceding claim in which the or each waveguide is a rib waveguide.

21. An integrated optical device as claimed in any preceding claim formed in a silicon light conducting layer.

22. An integrated optical device as claimed in claim 21 formed on a silicon-on-insulator chip or wafer.

23. An integrated optical device comprising an array of two or more rib waveguides formed in an optically conductive layer, each rib waveguide comprising a slab portion and rib projecting therefrom, substantially all of the optically conductive layer being removed from a selected region between the slab regions of the or each pair of adjacent waveguides.

24. An integrated optical device as claimed in claim 23 in which the slab regions of each rib waveguide have a width in the range 5 to 60 microns, and preferably in the range 20 to 30 microns.

25. An integrated optical device as claimed in any of claims 23 or 24 in which the optically conductive layer is separated from a substrate by an optical confinement layer, the optically conductive layer being removed in said selected region down to the optical confinement layer.

26. An integrated optical device as claimed in any preceding claim having light absorbing means at one or more edges of the substrate to absorb the re-directed stray light.

27. An integrated optical device substantially as hereinbefore described with reference to or as shown in one or more of the accompanying drawings.
